(19) United States
(12) Patent Application Publication
(10) Pub. No.: US 2020/0154656 A1
(43) Pub. Date: May 21, 2020

(54) CEILING-MOUNTED MOISTURE DISTRIBUTION APPARATUS

(71) Applicant: Dennis Taussig, Tully, NY (US)

(72) Inventor: Dennis Taussig, Tully, NY (US)

(21) Appl. No.: 16/193,390

(22) Filed: Nov. 16, 2018

(51) Int. Cl. A01G 27/00; F16M 13/02; A47G 7/04

(52) U.S. Cl. CPC A01G 27/003; A47G 7/047; F16M 13/027

(57) ABSTRACT

A ceiling-mounted moisture distribution apparatus provides a housing mounted to a ceiling surface for supporting a plant container and discharging a liquid directly onto a plant. The housing has an elongated aesthetic design for hanging the apparatus in home and office settings. The housing mounts to a ceiling through an apertured flange. The apparatus concentrically supports a plant container from a ring mount for distributing moisture in a controllable manner directly onto plant. The apparatus also comprises an elongated housing that forms an inlet hole for receiving a liquid from an external liquid source. The housing has an outlet hole that is disposed generally below the inlet hole and above the plant for discharging the liquid onto the plant through pressure or gravity induced flow. A tube carries the liquid from the inlet hole to the outlet hole. Additionally, a valve at the tube regulates the discharge of the liquid.

### FIELD OF THE INVENTION

The present invention relates generally to a ceiling-mounted moisture distribution apparatus. More so, the present invention relates to a moisture distribution apparatus that mounts to a ceiling surface from an apertured flange while concentrically supporting a plant from a ring mount for distributing moisture in a controllable manner directly onto the plant; and whereby the moisture distribution apparatus forms an inlet hole for receiving a liquid from an external liquid source, at least one outlet hole disposed generally below the inlet hole and above the plant for discharging the liquid onto the plant through a pressure or gravity controlled flow, a tube for carrying the liquid from the inlet hole to the outlet hole, a valve to regulate the discharge of the liquid, and an elongated aesthetic design that allows for hanging the moisture distribution apparatus in indoor or outdoor settings.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Often, people who live in apartments or have limited office space have limited space for decorative plants and vegetation. Such users often try to crowd as many plants as possible in a small area near the window, but this gives the appearance of a cluttered room. Generally, a hanging plant includes a suspended container used for growing decorative plants. Typically hanging plants are hung from ceilings or buildings, where garden space is at a premium, and from street furniture for environmental enhancement. Hanging plants may also be suspended from free standing frames. Watering such hanging plants can be problematic, as each time a user must remove the hanging plant and lower it for watering.

Typically, there are myriad types of watering systems that provide water for plants. Such systems can include drip systems and emitter drip systems. Drip systems utilize the use of emitters to distribute water to plants in a specific manner. The use of emitter systems can be either for plants that are fixed to the ground or plants contained in hanging baskets. Use of emitter drip systems for hanging plants generally require utilizing a hook to hang the basket. The emitter system is then attached via wire to the basket. However, this configuration often requires a great deal adjustment to get the dispersion of water centered on the basket in an even congruent manner. Even slight movement of stimuli such as a breeze of wind or an accidental “bump” can change the position of a “wired” system whereas the device is automatically centered even after wind movement or accidental bump.

Other proposals have involved watering systems for feeding hanging plants. The problem with these watering systems is that they require the plant to be lowered for watering. Also, there is not a valve or timer to regulate the amount and pattern of water being discharged onto the plant. Even though the above cited watering systems meet some of the needs of the market, a moisture distribution apparatus that mounts to a ceiling surface from an apertured flange while concentrically supporting a plant from a ring mount for distributing moisture in a controllable manner directly onto the plant; and whereby the moisture distribution apparatus forms an inlet hole for receiving a liquid from an external liquid source, at least one outlet hole disposed generally below the inlet hole and above the plant for discharging the liquid onto the plant through a pressure or gravity induced controlled flow, a tube for carrying the liquid from the inlet hole to the outlet hole, a valve to regulate the discharge of the liquid, and an elongated aesthetic design that allows for hanging the moisture distribution apparatus in indoor or outdoor settings, is still desired.

### SUMMARY

Illustrative embodiments of the disclosure are generally directed to a ceiling-mounted moisture distribution apparatus. The moisture distribution apparatus provides a housing that mounts to a ceiling surface for supporting a plant container and discharging a liquid directly onto the plant contained therein. The housing is defined by an elongated aesthetic design. The housing is configured to mount to a ceiling through use of an apertured flange. The housing has a rounded ring mount that allows for hanging the plant container in home and office settings. The ring mount concentrically supports the plant container for distributing moisture in a controllable manner directly onto the plant.

In some embodiments, the moisture distribution apparatus comprises an elongated housing that forms an inlet hole for receiving a liquid from an external liquid source. The housing comprises at least one outlet hole disposed generally below the inlet hole and above the plant for discharging the liquid onto the plant through a pressure or gravity induced flow. The moisture distribution apparatus further comprises a tube for carrying the liquid from the inlet hole to the outlet hole. An external liquid source attaches to the inlet hole for providing a liquid to the tube. Additionally, a valve is used to regulate the discharge of the liquid from the outlet hole.

In one aspect, a ceiling-mounted moisture distribution apparatus, the apparatus comprising:
a. an elongated housing defined by a mount end, a discharge end, and a passageway extending between the mount and discharge ends, the mount end forming an inlet hole, the discharge end forming at least one outlet hole,
b. whereby the inlet hole is operable to enable receiving a liquid from an external liquid source;
c. an apertured flange joined to the mount end of the elongated housing, the apertured flange forming at least one aperture,
d. whereby the apertured flange is operable to enable mounting to a mounting surface;
e. a ring mount joined to the mount end of the elongated housing,
f. whereby the ring mount is operable to enable support of at least one plant container;
g. a tube passing through the passageway, the tube having a ceiling end and a plant end,
h. whereby the plant end of the tube is concentrically aligned over the plant container,
i. whereby the tube is operable to enable pressure or gravity controlled flowage of the liquid from the ceiling end to the plant end; and
j. a valve operatively connected to the plant end of the tube,
k. whereby the valve is operable to enable regulation of liquid being discharged through the outlet hole of the housing.

In another aspect, the apparatus further comprises a timer operatively connected to the valve. The timer can be connected to the tubing at the water source, usually the spigot on the outside of a home for example, to automate the watering process.

In another aspect, the timer controls the flow of water to the valve, whereby the liquid is controllably discharged.

In another aspect, the ring mount is defined by a profile that tapers from ½ inch to 5/16 inch.

In another aspect, the ring mount is defined by a rounded ridge.

In another aspect, the elongated housing is defined by a curved surface. The curved surface is necessary to allow the basket to move in strong wind without damaging the device. The curved surface also allows plant container to move if someone or something bumps into the basket.

In another aspect, the at least one aperture forming in the apertured flange comprises two screw holes.

In another aspect, the mounting surface is a ceiling.

In another aspect, the apparatus further comprises at least one fastener.

In another aspect, the fastener passes through the aperture in the apertured flange.

In another aspect, the tube comprises a resilient polymer.

In another aspect, the valve comprises a flow control valve.

In another aspect, the plant container comprises a hook and a plurality of cables suspended from the ring mount.

In another aspect, the plant container contains a plant.

In another aspect, the apparatus further comprises a connecter plug, the connector plug being fitted into the inlet hole of the housing.

In another aspect, the external liquid source is a water hose.

In another aspect, the liquid is water.

In another aspect, multiple apparatuses are joined through the same external liquid source.

One objective of the present invention is to water a plant while the plant is being supported from the ceiling.

Another objective of the invention is to provide even congruent distribution of water to the plant.

Another objective is to leverage pressure or gravity controlled flowage of water to distribute moisture on the plant.

Another objective is to center the ring mount so that the plant hangs concentrically beneath the discharge end of the housing.

Another objective is to allow 3 wires that are suspended from the plant container to support the basket to hang freely from the ring and beneath the device and move to accommodate wind and any accidental collision/bump with the plant container.

Another objective is to shape the ring mount with a tapered, rounded ridge for facilitated hanging and removal of the plant.

Yet another objective is to facilitate hanging of plant container for watering.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 illustrates a perspective view of an exemplary ceiling-mounted moisture distribution apparatus supporting a hanging plant, in accordance with an embodiment of the present invention;

FIG. 2 illustrates a perspective view of the ceiling-mounted moisture distribution apparatus shown in FIG. 1, in accordance with an embodiment of the present invention;

FIG. 3 illustrates a sectioned side view of the ceiling-mounted moisture distribution apparatus shown in FIG. 1, in accordance with an embodiment of the present invention; and

FIG. 4 illustrates a sectioned frontal view of the ceiling-mounted moisture distribution apparatus shown in FIG. 1, in accordance with an embodiment of the present invention.

Like reference numerals refer to like parts throughout the various views of the drawings.

### DETAILED DESCRIPTION OF THE INVENTION

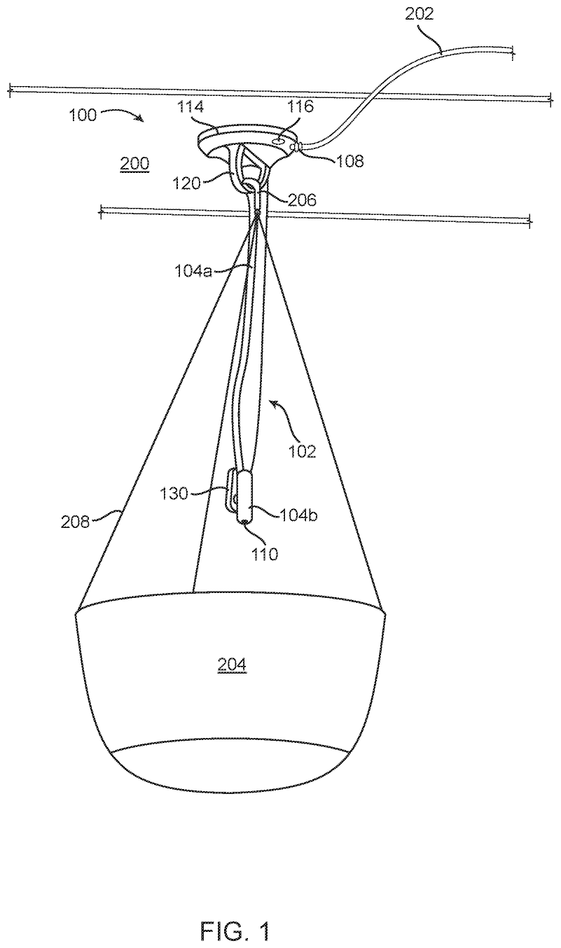

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A ceiling-mounted moisture distribution apparatus 100 is referenced in FIGS. 1-4. Ceiling-mounted moisture distribution apparatus 100, hereafter “apparatus 100” supports a plant container 204 concentrically from a mounting surface 200, such as a ceiling, while discharging a liquid, such as water, directly on a plant that is contained in the plant container 204. As FIG. 1 illustrates, apparatus 100 comprises an elongated housing 102 that forms the supportive framework and structural integrity for mounting to a mounting surface 200, supporting the weight of a plant container 204, and aligning a tube 124 to discharge a liquid directly onto the plant contained in the plant container 204.

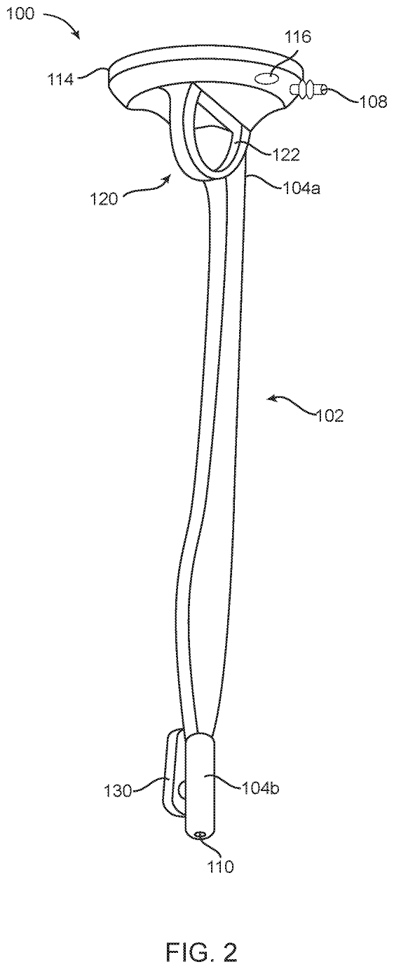

As shown in FIG. 2, housing 102 is defined by a mount end 104a from which apparatus 100 is mounted to mounting surface 200 and through which liquid enters. Housing is further defined by an oppositely disposed discharge end 104b from which plant container 204 is supported and liquid discharges from the tube 124 onto the plant. In one non-limiting embodiment, housing 102 is defined by a curved surface.

This curved surface configuration allows multiple wires (3 wires shown in FIG. 1) that are suspended from the plant container 204 to support the basket to hang freely from the ring 120 and beneath the device and move to accommodate wind and any accidental collision/bump with the plant container 204. Housing 102 may be fabricated from various lightweight, rigid materials, including, without limitation: polyurethane, polyvinyl chloride, a rigid polymer, aluminum, a metal alloy, wood, and fiberglass.

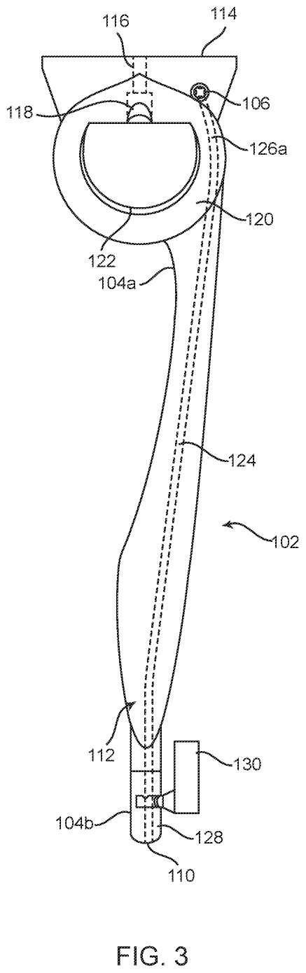

As illustrated in FIG. 3, apparatus 100 further includes an apertured flange 114 joined to the mount end 104a of the elongated housing 102. Apertured flange 114 forms at least one aperture 116 that is sized and dimensioned to enable at least one fastener 118, such as a screw or bolt, to pass through for mounting to a mounting surface 200. In one embodiment, the aperture forming in apertured flange 114 comprises two screw holes that have a threaded ridge to rotatably receive two screws. In this manner, apertured flange 114 mounts the housing 102 to a mounting surface 200. In one embodiment, the mounting surface 200 is a ceiling.

Looking at FIG. 2, apparatus 100 further comprises a ring mount 120 joined to the mount end 104a of housing 102. Ring mount 120 is configured to support at least one plant container 204. In some embodiments, ring mount 120 is defined by a profile that tapers from ½″ to 5/16″. Ring mount 120 is also defined by a rounded ridge 122 for easy-on, easy-off loading of the plant container 204 thereon. In one non-limiting embodiment shown in FIG. 1, plant container 204 comprises a hook 206 and a plurality of cables 208 suspended from the ring mount 120. Plant container 204 may be configured to contain soil and a plant, including a house plant, a fern, a vegetable, a fruit, and any vegetation known in the art.

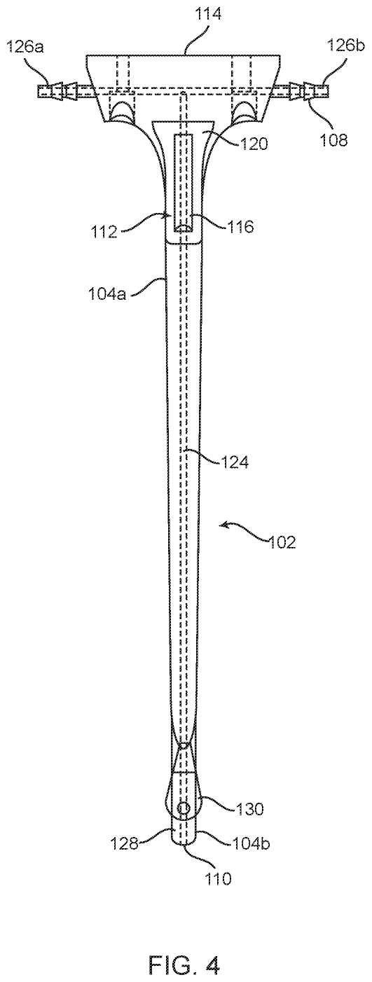

As FIGS. 3 and 4 show, a passageway 112 extends between mount end 104a and discharge end 104b of housing 102. Passageway is sized and dimensioned to enable passage of a tube 124, as described below. In one non-limiting embodiment, mount end 104a of housing 102 forms an inlet hole 106 through which liquid ingresses. Discharge end 104b of housing 102 forms at least one outlet hole 110 through which liquid egresses.

In one non-limiting embodiment, inlet hole 106 that forms through housing 102 is sized and dimensioned to receive an external liquid source that is carrying a liquid. The external liquid source may be a water hose, a water plug, or other external source 202 of liquid, water, vegetation nutritional fluid, and the like. In one non-limiting embodiment, apparatus 100 provides a connecter plug. Connector plug 108 is fitted into the inlet hole 106 of housing 102. Connector plug 108 may be tapered or have barbs to create a friction fit connection with inlet hole 106. In one non-limiting embodiment, inlet and outlet holes 106, 110 may be circular and have a small cross section that allows for passage of a small tube 124 for carrying the liquid to the plant.

Looking again at FIG. 2, a tube 124 carries the liquid from external source 202 to the plant. Tube 124 passes through the passageway 112 in the housing 102. Tube 124 is defined by a ceiling end 126a, 126b oriented towards the mounting surface 200, and a plant end 128 oriented towards the plant container 204. Specifically, plant end 128 of tube 124 is concentrically aligned over the plant container 204. This allows for concentric and direct discharge of liquid onto the plant. In one non-limiting embodiment, tube 124 is flexible and fabricated from a resilient polymer. Thus, the orientation of tube 124 enables tube 124 to carry the liquid through a pressure or gravity controlled flowage from the ceiling end 126a, 126b of tube, all the way down to the plant end 128 of tube 124.

Additionally, apparatus 100 provides a valve 130 that operatively connects to plant end 128 of tube 124. In this manner, valve 130 is operable to enable regulation of liquid being discharged through the outlet hole 110 of the housing 102. In one non-limiting embodiment, valve 130 comprises a flow control valve 130. In another embodiment, valve 130 comprises a mechanical, hand-controlled flow control valve 130. Yet in other embodiments, an electronic valve. This may be either an external timer, an electronic digital timer, or an electronic valve may be used to regulate the flow of liquid through tube 124.

In one non-limiting embodiment, apparatus 100 provides a timer that operatively controls the flow of liquid to the valve, such as to an external spigot or liquid source. Timer is configured to regulate the valve 130; and thereby control discharge of the liquid from plant end 128 of tube 124. For example, timer can be preset to discharge liquid from the tube 124 everyday day 6 am for one hour. The valve controls the flow of water out of the apparatus. The apparatus is operable with or without a timer.

In an alternative embodiment of the present invention, multiple apparatuses are joined in series through the same external liquid source. In this arrangement, a carrier tube connects all of the apparatuses, carrying liquid to each individual tube in the housing from external source 202. This series-arrangement can be useful for large agricultural It is significant to note that most homes have more than 1 hanging basket. For example, a user may have 6 hanging baskets, 3 on each side with the front door being in the center. The apparatus 100 may be useful for watering this multitude of plants. Further, greenhouses or other such enterprises might use the apparatus 100 to save manpower hours that it would take to water a large number of hanging baskets.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A ceiling-mounted moisture distribution apparatus, the apparatus comprising:
an elongated housing defined by a mount end, a discharge end, and a passageway extending between the mount and discharge ends, the mount end forming an inlet hole, the discharge end forming at least one outlet hole,
whereby the inlet hole is operable to enable receiving a liquid from an external liquid source;
an apertured flange joined to the mount end of the elongated housing, the apertured flange forming at least one aperture,
whereby the apertured flange is operable to enable mounting to a mounting surface;
a ring mount joined to the mount end of the elongated housing,
whereby the ring mount is operable to enable support of at least one plant container;
a tube passing through the passageway, the tube having a ceiling end and a plant end,
whereby the plant end of the tube is concentrically aligned over the plant container,
whereby the tube is operable to enable pressure or gravity controlled flowage of the liquid from the ceiling end to the plant end; and
a valve operatively connected to the plant end of the tube,
whereby the valve is operable to enable regulation of liquid being discharged though the outlet hole of the housing.

2. The apparatus of claim 1, further comprising a timer.

3. The apparatus of claim 2, wherein the timer controls the flow of liquid to the valve.

4. The apparatus of claim 1, wherein the ring mount is defined by a profile that tapers from ½ inch to 5/16 inch.

5. The apparatus of claim 1, wherein the ring mount is defined by a rounded ridge.

6. The apparatus of claim 1, wherein the elongated housing is defined by a curved surface.

7. The apparatus of claim 1, wherein the at least one aperture forming in the apertured flange comprises two screw holes.

8. The apparatus of claim 1, wherein the mounting surface is a ceiling.

9. The apparatus of claim 1, further comprising at least one fastener.

10. The apparatus of claim 9, wherein the fastener passes through the aperture in the apertured flange.

11. The apparatus of claim 1, further comprising a connecter plug, the connector plug being fitted into the inlet hole of the housing.

12. The apparatus of claim 1, wherein the tube comprises a resilient polymer.

13. The apparatus of claim 1, wherein the valve comprises a flow control valve.

14. The apparatus of claim 1, wherein the plant container comprises a hook and a plurality of cables suspended from the ring mount.

15. The apparatus of claim 1, further comprising an external liquid source joined to the inlet hole.

16. The apparatus of claim 1, wherein the external liquid source comprises a water hose.

17. The apparatus of claim 1, wherein multiple apparatuses are joined through the same external liquid source.

18. A ceiling-mounted moisture distribution apparatus, the apparatus comprising:
an elongated housing defined by a mount end, a discharge end, and a passageway extending between the mount and discharge ends, the mount end forming an inlet hole, the discharge end forming at least one outlet hole,
whereby the inlet hole is operable to enable receiving a liquid from an external liquid source;
a connecter plug being fitted into the inlet hole of the housing;
an apertured flange joined to the mount end of the elongated housing, the apertured flange forming at least one aperture,
whereby the apertured flange is operable to enable mounting to a mounting surface;
a ring mount joined to the mount end of the elongated housing, the ring mount being defined by a rounded ridge,
whereby the ring mount is operable to enable support of at least one plant container;
a tube passing through the passageway, the tube having a ceiling end and a plant end,
whereby the plant end of the tube is concentrically aligned over the plant container,
whereby the tube is operable to enable pressure or gravity controlled flowage of the liquid from the ceiling end to the plant end;
a valve operatively connected to the plant end of the tube,
whereby the valve is operable to enable regulation of liquid being discharged through the outlet hole of the housing; and
a timer controlling the flow of liquid to the valve, whereby the liquid is controllably discharged.

19. The apparatus of claim 18, further comprising an external liquid source joined to the connecter plug.

20. A ceiling-mounted moisture distribution apparatus, the apparatus consisting of:
an elongated housing defined by a mount end, a discharge end, and a passageway extending between the mount and discharge ends, the mount end forming an inlet hole, the discharge end forming at least one outlet hole,
whereby the inlet hole is operable to enable receiving a liquid from an external liquid source;
a connecter plug being fitted into the inlet hole of the housing;
an apertured flange joined to the mount end of the elongated housing, the apertured flange forming at least one aperture,
whereby the apertured flange is operable to enable mounting to a mounting surface;
at least one fastener passing through the aperture in the apertured flange;
a ring mount joined to the mount end of the elongated housing, the ring mount being defined by a rounded ridge,
whereby the ring mount is operable to enable support of at least one plant container;
a tube passing through the passageway, the tube having a ceiling end and a plant end,
whereby the plant end of the tube is concentrically aligned over the plant container,
whereby the tube is operable to enable pressure or gravity controlled flowage of the liquid from the ceiling end to the plant end;
a valve operatively connected to the plant end of the tube,
whereby the valve is operable to enable regulation of liquid being discharged though the outlet hole of the housing;
a timer controlling the flow of liquid to the valve, whereby the liquid is controllably discharged; and
an external liquid source joined to the connecter plug.
